(19) United States
(12) Patent Application Publication
(10) Pub. No.: US 2012/0056792 A1
(43) Pub. Date: Mar. 8, 2012

(54) WEARABLE DEVICE WITH ANTENNA

(75) Inventor: PING HAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/916,631

(22) Filed: Oct. 31, 2010

(30) Foreign Application Priority Data
Sep. 3, 2010 (CN) 201010271810.2

(51) Int. Cl. H01Q 1/12

(52) U.S. Cl. 343/718

(57) ABSTRACT

A wearable device includes a housing, a circuit board, a strap, and two antennas. The housing defines a receiving space. The receiving space includes two sidewalls each defining a through hole. The circuit board is received in the receiving space. The strap defines two slots respectively adjacent to the sidewalls. The antennas extend from the circuit board and are electrically connected to the circuit board. Each of the antennas is received in a corresponding slot.

### BACKGROUND

1. Technical Field

The present disclosure relates to wearable devices and, particularly, to a wearable device with an antenna.

2. Description of Related Art

Wristwatches capable of receiving and transmitting wireless signals are available now with embedded antennas. However, metal portions of the wristwatches may block or otherwise interfere with signal transceiving.

### BRIEF DESCRIPTION OF THE DRAWINGS

The components of the drawings are not necessarily drawn to scale, the emphasis instead being placed upon clearly illustrating the principles of a wearable device. Moreover, in the drawings, like reference numerals designate corresponding parts throughout several views.

FIG. 1 is an isometric view of a wearable device in accordance with an exemplary embodiment.

FIG. 2 is an exploded, perspective view of the wearable device of FIG. 1.

FIG. 3 is a cross-section of the wearable device of FIG. 1, taken along line III-III.

### DETAILED DESCRIPTION

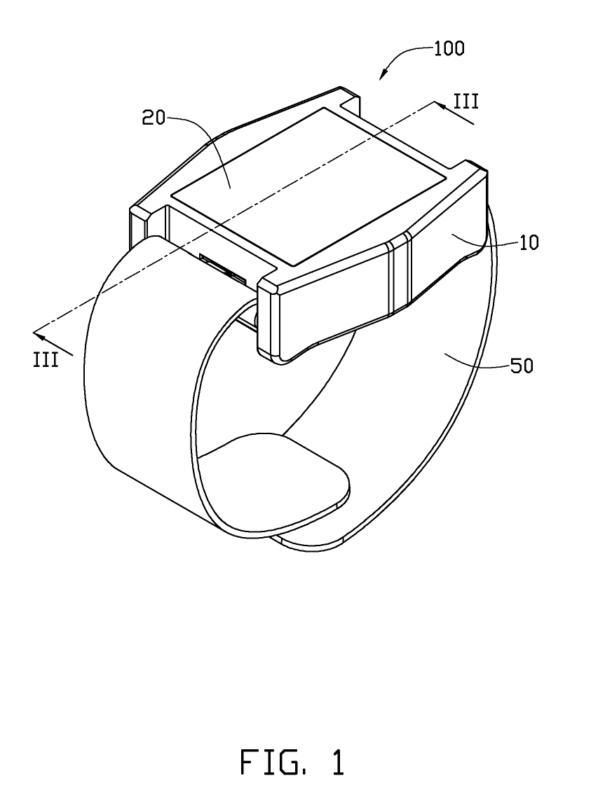

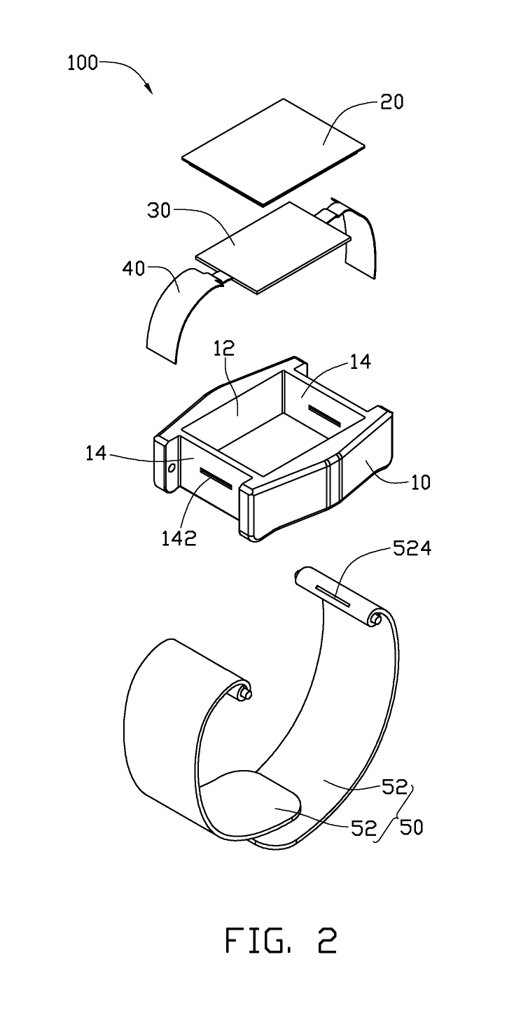

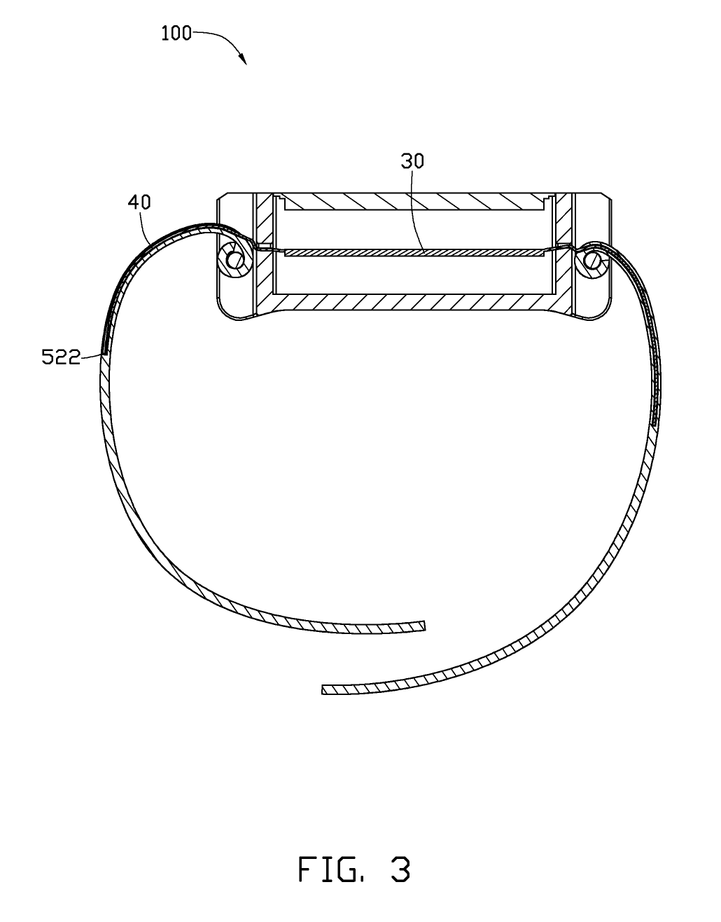

Referring to FIGS. 1-3, an embodiment of a wearable device 100 is illustrated. The device 100 includes a housing 10, a display 20, a circuit board 30, at least one antenna 40, and a strap 50. In this embodiment, the device 100 is a wristwatch.

In this embodiment, two antennas 40 are deployed. The antennas 40 are electrically connected to the circuit board 30 and respectively extend from opposite ends of the circuit board 30. The antennas 40 are flexible printed circuits (FPC), and each antenna 40 is substantially bar-shaped. The number and the shape of the antennas 40 can be varied according to need.

The housing 10 defines a receiving space 12 to receive the display 20 and the circuit board 30. The receiving space 12 includes two opposite sidewalls 14 each defining a through hole 142 to allow the antenna 40 to pass through. The strap 50 includes two sub-straps 52. The sub-straps 52 can be made of a material that will not block wireless signals, such as rubber, leather, or the like. The sub-straps 52 are respectively secured to the housing 10 and adjacent to the sidewalls 14. Each sub-strap 52 defines a longitudinal slot 522 with an opening 524. Each antenna 40 is extended through the corresponding through hole 142 and received in the slot 522 through the opening 524.

With such configuration, the antennas 40 are embedded in the sub-straps 52 and will not interfere with wireless signals.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A wearable device comprising:
a housing defining a receiving space, the receiving space comprising at least one sidewall defining a through hole;
a circuit board received in the receiving space;
a strap defining at least one slot, each of the at least one slot defining an opening adjacent to one of the at least one through hole; and
at least one antenna each extending from the circuit board and electrically connected to the circuit board, each of the at least one antenna being extended through one of the at least one through hole and received in one of the at least one slot by passing through the opening of the one of the at least one slot.

2. The wearable device as described in claim 1, wherein the at least one antenna comprises two antennas, the antennas respectively extends from opposite ends of the circuit board.

3. The wearable device as described in claim 1, wherein each of the at least one antenna is a flexible printed circuit.

4. The wearable device as described in claim 1, wherein each of the at least one antenna is bar-shaped.

5. The wearable device as described in claim 1, wherein the strap is made of rubber.

6. The wearable device as described in claim 1, wherein the strap is made of leather.

7. The wearable device as described in claim 1, wherein the wearable device is a wristwatch.
